(19) United States
(12) Patent Application Publication
(10) Pub. No.: US 2025/0292756 A1
(43) Pub. Date: Sep. 18, 2025

(54) SOUND ABSORPTION APPARATUS AND ACOUSTIC META MATERIAL

(71) Applicant: KABUSHIKI KAISHA TOSHIBA, Tokyo (JP)

(72) Inventor: Tatsuhiko Goto, Kawasaki Kanagawa (JP)

(73) Assignee: KABUSHIKI KAISHA TOSHIBA, Tokyo (JP)

(21) Appl. No.: 19/050,890

(22) Filed: Feb. 11, 2025

(30) Foreign Application Priority Data
Mar. 18, 2024 (JP) 2024-042684

(51) Int. Cl. G10K 11/172; G10K 11/162

(52) U.S. Cl. CPC G10K 11/172; G10K 11/162

(57) ABSTRACT

According to an embodiment, a sound absorption apparatus includes a front plate, an oscillator, a first frame member, a back plate, and a second frame member. The front plate includes sound holes. The first frame member is connected to the front plate and the oscillator, and forms a first space between the front plate and the oscillator. The second frame member is connected to the back plate and the oscillator, and forms a second space between the back plate and the oscillator. The oscillator includes a diaphragm, a third frame member and a central member which are attached to the diaphragm, and a connecting member coupling the third frame member and the central member. The first frame member includes a space dividing member that divides the first space.

### CROSS-REFERENCE TO RELATED APPLICATION

This application is based upon and claims the benefit of priority from Japanese Patent Application No. 2024-042684, filed Mar. 18, 2024, the entire contents of which are incorporated herein by reference.

### FIELD

Embodiments described herein relate generally to a sound absorption apparatus and an acoustic meta material.

### BACKGROUND

A common sound absorption material has advantages that the cost is low, the thickness is thin, and the sound absorption band is broad at 1 kHz or higher, but has disadvantages that the sound absorption material cannot be used in a high-temperature environment, deterioration over time occurs, the environmental load is large in a case of a glass wool-based sound absorption material, some thickness is needed in use for a low frequency band, etc.

A Helmholtz resonator is known as a sound absorption apparatus that reduces sound such as noise. The Helmholtz resonator is a container of which the internal space is connected to the external space via a sound hole. In the Helmholtz resonator, resonance occurs in the internal space due to sound that has entered via the sound hole, and thereby the vibration energy of the entered sound at a resonance frequency can be attenuated. The Helmholtz resonator has a one-degree-of-freedom system, and thus has uni-modal sound absorption characteristics. The Helmholtz resonator can be used for a low frequency band depending on the design.

A Helmholtz resonator of a two-degrees-of-freedom system is proposed from the viewpoint of expanding sound absorption characteristics to a wider band. The Helmholtz resonator of a two-degrees-of-freedom system has a structure in which an elastic plate is added to a Helmholtz resonator of a one-degree-of-freedom system in such a way as to separate the internal space into two spaces. The elastic plate has a one-degree-of-freedom system, and the Helmholtz resonator has a one-degree-of-freedom system; and a two-degrees-of-freedom system is obtained by coupling of the Helmholtz resonator and the elastic plate. The Helmholtz resonator of a two-degrees-of-freedom system has sound absorption characteristics in which a sound absorption coefficient peak is separated into two. A valley characteristic (a drop in sound absorption coefficient) occurs between the two sound absorption coefficient peaks.

In the sound absorption apparatus, it is required to obtain a sound absorption effect in a wide frequency band.

### BRIEF DESCRIPTION OF DRAWINGS

FIG. 1 is a perspective view showing a sound absorption apparatus according to an embodiment.

FIG. 2 is an exploded view showing the sound absorption apparatus according to the embodiment.

FIG. 3 is an exploded view showing the sound absorption apparatus according to the embodiment.

FIG. 4 is a cross-sectional view showing the sound absorption apparatus according to the embodiment.

FIG. 5 is a perspective view showing part of the sound absorption apparatus according to the embodiment.

FIG. 6 is a perspective view showing part of the sound absorption apparatus according to the embodiment.

FIG. 7 is a plan view showing part of the sound absorption apparatus according to the embodiment.

FIG. 8 is a perspective view showing a supporting member according to the embodiment.

FIG. 9 is a plan view showing a supporting member according to the embodiment.

FIG. 10 is a plan view showing part of a sound absorption apparatus according to a first example.

FIG. 11 is a plan view showing part of a sound absorption apparatus according to a second example.

FIG. 12 is a plan view showing part of a sound absorption apparatus according to a third example.

FIG. 13 is a cross-sectional view showing a sound absorption apparatus according to a first comparative example.

FIG. 14 is a cross-sectional view showing a sound absorption apparatus according to a second comparative example.

FIG. 15 is a cross-sectional view showing a sound absorption apparatus according to a third comparative example.

FIG. 16 is a diagram showing sound absorption performance of sound absorption apparatuses according to the first example.

FIG. 17 is a diagram showing sound absorption performance of sound absorption apparatuses according to the second example.

FIG. 18 is a diagram showing, for sound absorption apparatuses according to the third comparative example, comparison between sound absorption performance according to the first example and sound absorption performance according to the second example.

FIG. 19 is a diagram showing, for sound absorption apparatuses according to the embodiment, comparison between sound absorption performance according to the first example and sound absorption performance according to the second example.

FIG. 20 is a diagram showing sound absorption performance of sound absorption apparatuses according to the third example.

FIG. 21 is a diagram showing, for sound absorption apparatuses according to the embodiment, comparison between sound absorption performance according to the first example and sound absorption performance according to the third example.

FIG. 22 is a perspective view showing an acoustic meta material according to an embodiment.

FIG. 23 is a perspective view showing a sound absorption unit according to the embodiment.

FIG. 24 is an exploded view showing the sound absorption unit according to the embodiment.

FIG. 25 is a perspective view showing part of the sound absorption unit according to the embodiment.

FIG. 26 is a perspective view showing part of the sound absorption unit according to the embodiment.

FIG. 27 is a perspective view showing an acoustic meta material according to an embodiment.

FIG. 28 is a perspective view showing a sound absorption unit according to the embodiment.

FIG. 29 is a perspective view showing part of the sound absorption unit according to the embodiment.

FIG. 30 is a diagram showing sound absorption characteristics of the sound absorption unit shown in FIG. 28.

FIG. 31 is a diagram showing both sound absorption characteristics of the sound absorption unit shown in FIG. 23 and sound absorption characteristics of the sound absorption unit shown in FIG. 28.

FIG. 32 is a perspective view showing an acoustic meta material according to an embodiment.

FIG. 33 is a perspective view showing a sound absorption unit shown in FIG. 32.

FIG. 34 is a perspective view showing the sound absorption unit shown in FIG. 32.

FIG. 35 is a perspective view showing part of the sound absorption unit shown in FIG. 32.

FIG. 36 is a perspective view showing part of the sound absorption unit shown in FIG. 32.

### DETAILED DESCRIPTION

According to an embodiment, a sound absorption apparatus includes a front plate, an oscillator, a first frame member, a back plate, and a second frame member. The front plate includes a plurality of sound holes. The oscillator faces the front plate. The first frame member is connected to the front plate and the oscillator, the first frame member forming a first space between the front plate and the oscillator. The back plate faces the oscillator. The second frame member is connected to the back plate and the oscillator, the second frame member forming a second space between the back plate and the oscillator. The oscillator includes a diaphragm, a third frame member attached to the diaphragm, a central member attached to the diaphragm, and a connecting member coupling the third frame member and the central member. The first frame member includes a space dividing member that divides the first space.

According to an embodiment, there is provided a sound absorption apparatus capable of absorbing sound in a wide frequency band.

Hereinafter, embodiments will be described with reference to the accompanying drawings.

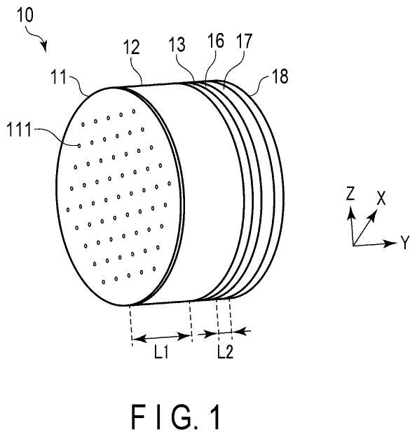

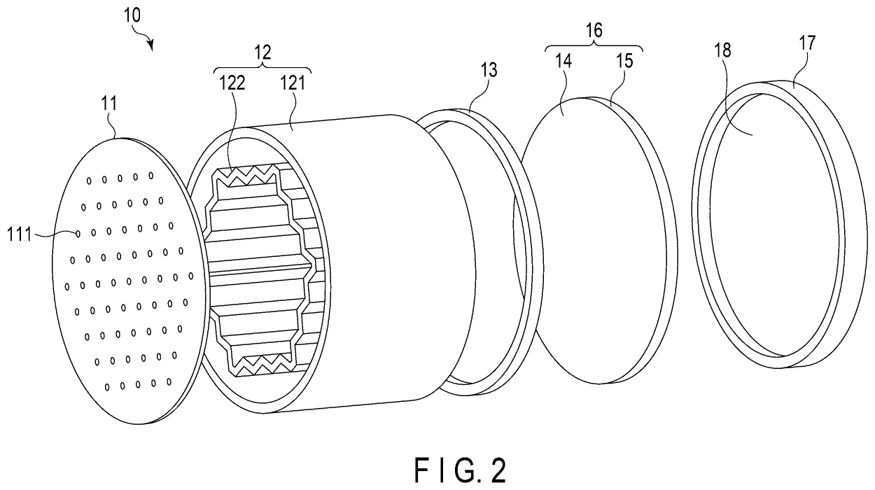

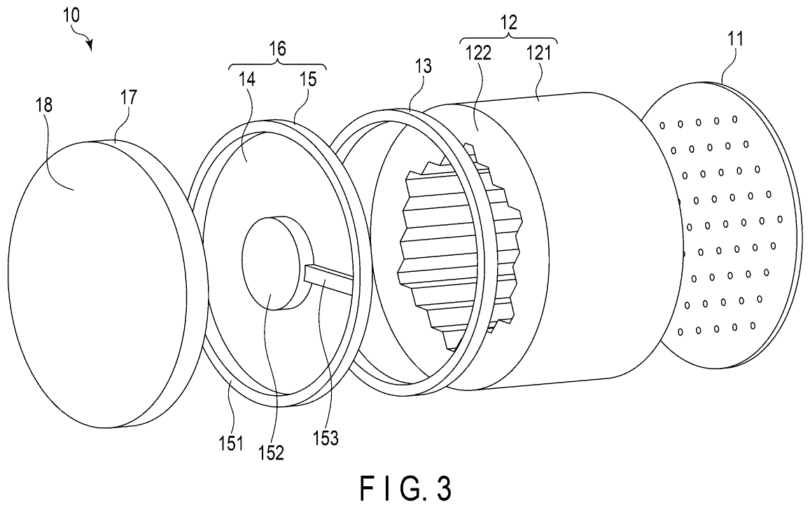

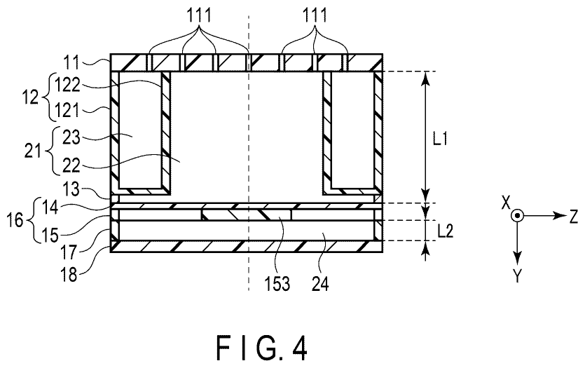

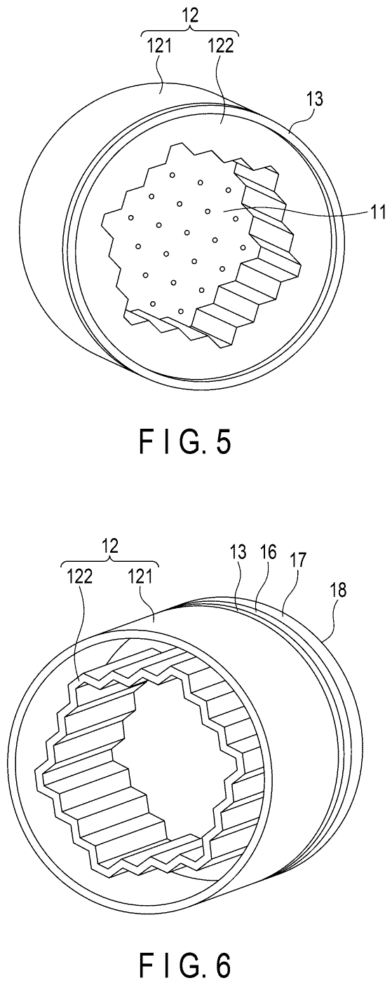

FIG. 1 schematically shows a sound absorption apparatus 10 according to an embodiment, FIGS. 2 and 3 schematically show the sound absorption apparatus 10 in a disassembled state, FIG. 4 schematically shows a cross section of the sound absorption apparatus 10, and FIGS. 5, 6, 7, and 8 schematically show parts of the sound absorption apparatus 10. The sound absorption apparatus 10 is configured to absorb sound generated in the external space. The sound absorption apparatus 10 is used to, for example, reduce noise.

As shown in FIGS. 1 to 7, the sound absorption apparatus 10 includes a perforated front plate 11, a frame member 12, a spacer 13, an oscillator 16, a frame member 17, and a back plate 18. The sound absorption apparatus 10 has, for example, a circular cylindrical shape as a whole. Hereinbelow, an example in which each configuration of the sound absorption apparatus 10 is in a circular shape is described. The shape of each configuration may be a polygonal shape or a figure surrounded by an arbitrary closed curve instead of a circle. A circular cylinder, a circular ring, a circular ring member, and a circular column can be read as a cylinder, a ring, a ring member, and a column.

The perforated front plate 11 is, for example, a circular flat plate provided with a plurality of sound holes 111. The diameter of the sound hole 111 is, for example, 0.1 mm or more and 20 mm or less. The diameter of the sound hole 111 is, for example, 0.2 times or less the diameter of the perforated front plate 11. Here, an XYZ orthogonal coordinate system is introduced for the sake of description. A Y-axis is defined in a direction perpendicular to the main surface of the perforated front plate 11, and an X-axis and a Z-axis are defined in directions parallel to the main surface of the perforated front plate 11. Further, for the sake of description, the upper and lower sides are defined such that the perforated front plate 11 is on the upper side and the back plate 18 is on the lower side. In the following, the length and the thickness refer to dimensions in the Y-axis direction (a direction parallel to the Y-axis).

The frame member 12 is, for example, a circular cylindrical member. In FIGS. 1 and 4, L1 represents the length of the frame member 12. The spacer 13 is, for example, a circular ring-like member. The frame member 12 and the spacer 13 may be integrally molded. The oscillator 16 is, for example, in a circular shape as a whole. The oscillator 16 faces the perforated front plate 11 in the Y-axis direction. The frame member 17 is, for example, a circular cylindrical member. The circular cylindrical cross-sectional shape and the cross-sectional area along the XZ plane are not necessarily fixed. In FIGS. 1 and 4, L2 represents the length of the frame member 17. The back plate 18 is, for example, a circular flat plate. The frame member 17 and the back plate 18 may be integrally molded. The back plate 18 faces the oscillator 16 in the Y-axis direction. The oscillator 16 is located between the perforated front plate 11 and the back plate 18.

The frame member 12 forms an internal space 21 between the perforated front plate 11 and the oscillator 16. The perforated front plate 11 is connected to the frame member 12 in such a way as to close a first opening end of the frame member 12. The oscillator 16 is connected to the frame member 12 via the spacer 13 in such a way as to close a second opening end of the frame member 12. The oscillator 16 is apart by length L1 from the perforated front plate 11. The internal space 21 communicates with the external space via the sound holes 111. The sound hole 111 functions as a path through which sound generated in the external space enters the internal space 21 of the sound absorption apparatus 10.

The frame member 12 includes an outer frame 121 and a space dividing member (also referred to as a slit member) 122 provided on the inside of the outer frame 121. Each of the outer frame 121 and the space dividing member 122 is in a cylindrical shape. The space dividing member 122 divides the internal space 21 into partial spaces 22 and 23. An end portion of the outer frame 121 and an end portion of the space dividing member 122 are connected by a ring-like bottom plate, and one end of the partial space 23 between the outer frame 121 and the space dividing member 122 is closed by the bottom plate. The space dividing member 122 is not closed by the bottom plate. An opening end, i.e., an unclosed end, of the outer frame 121 and the space dividing member 122 are connected to the perforated front plate 11. The partial space 22 is a space surrounded by the perforated front plate 11, the frame member 12, the spacer 13, and the oscillator 16, and is in contact with the oscillator 16. The partial space 23 is a space surrounded by the perforated front plate 11 and the frame member 12. The partial space 23 is a space separated from the partial space 22, and is isolated from the oscillator 16. The partial space 23 is provided to surround the partial space 22, that is, the partial space 23 is located on the outside of the partial space 22. Also, a configuration in which the partial space 23 is located on the inside of the partial space 22 is possible.

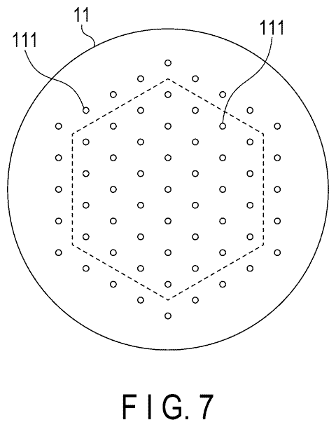

In FIG. 7, the broken line schematically shows a position where the perforated front plate 11 is in contact with the space dividing member 122. Each of the sound holes 111 located inside the broken line function as a path through which sound generated in the external space enters the partial space 22. Each of the sound holes 111 located outside the broken line functions as a path through which sound generated in the external space enters the partial space 23.

As shown in FIGS. 2 to 4, the frame member 17 forms an internal space 24 between the oscillator 16 and the back plate 18. The internal space 24 is a closed space surrounded by the oscillator 16, the frame member 17, and the back plate 18. The internal space 24 is separated from the internal space 21 and the external space. The oscillator 16 is connected to the frame member 17 in such a way as to close a first opening end of the frame member 17. The back plate 18 is connected to the frame member 17 in such a way as to close a second opening end of the frame member 17. The oscillator 16 is apart by length L2 from the back plate 18.

The connection between two components (for example, the connection between the perforated front plate 11 and the frame member 12) may be made by any means such as bonding using an adhesive or the like or fixing using a fixing tool such as bolts described later.

As shown in FIGS. 3 and 4, the oscillator 16 includes a diaphragm 14 and a supporting member 15 that supports the diaphragm 14. The diaphragm 14 is, for example, a circular thin membrane or film. The diaphragm 14 may be made of, for example, an elastic material such as polyvinyl chloride (PVC), silicon rubber, fluororubber, silicone rubber, acrylic rubber, ethylene propylene rubber, or an ethylene-vinyl acetate copolymer. As shown in FIGS. 3, 4, and 8, the supporting member 15 includes a frame member 151, a central member 152 located on the inside of the frame member 151, and a connecting member 153 coupling the frame member 151 and the central member 152. The frame member 151 and the central member 152 of the supporting member 15 are attached to the diaphragm 14. The attachment of the frame member 151 and the central member 152 to the diaphragm 14 may, for example, be made by bonding using an adhesive, a double-sided tape, or the like, or be made by fixing using a magnet. For example, the diaphragm 14 may be fixed to the central member 152 by sandwiching the diaphragm 14 between a rubber magnet attached to the central member 152 and a rubber magnet attached to a central portion of the upper surface of the diaphragm 14. The frame member 151 is, for example, a circular ring-like member, and the central member 152 is, for example, a circular columnar member. The center of gravity of the central member 152 may be located on the center axis (in FIG. 4, indicated by the broken line) of the sound absorption apparatus 10. The connecting member 153 may be a beam member extending in the diametrical direction (in a direction perpendicular to the Y-axis). The connecting member 153 supports the central member 152 such that the central member 152 is capable of vibrating or oscillating with respect to the frame member 151. The central member 152 is supported by the connecting member 153 in such a way as to vibrate or oscillate in the Y-axis direction.

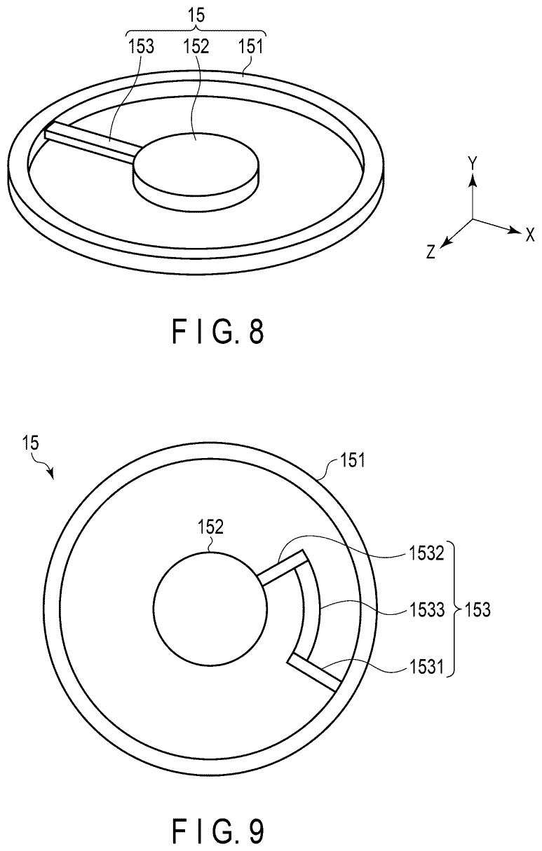

The structure of the supporting member 15 shown in FIG. 8 is an example. The connecting member 153 may be any structure as long as it supports the central member 152 such that the central member 152 is capable of vibrating with respect to the frame member 151. In the example shown in FIG. 9, the connecting member 153 includes straight-lined beam members 1531 and 1532 and an arc-shaped beam member 1533. A first end portion of the beam member 1531 is connected to the frame member 151, a second end portion of the beam member 1531 is connected to a first end portion of the beam member 1533, a first end portion of the beam member 1532 is connected to a second end portion of the beam member 1533, and a second end portion of the beam member 1532 is connected to the central member 152. There may be two or more connecting members 153.

As shown in FIGS. 3 and 4, in the oscillator 16, the diaphragm 14 is located on the frame member 12 side, and the supporting member 15 is located on the frame member 17 side. An outer edge portion of the upper surface of the diaphragm 14 is connected to the frame member 12 via the spacer 13, an outer edge portion of the lower surface of the diaphragm 14 is connected to the upper surface of the frame member 151 of the supporting member 15, a central portion of the lower surface of the diaphragm 14 is connected to the upper surface of the central member 152 of the supporting member 15, and the lower surface of the frame member 151 of the supporting member 15 is connected to the frame member 17. The spacer 13 is provided such that the oscillator 16 (specifically, the diaphragm 14) does not come into contact with the space dividing member 122 of the frame member 12. Also, a configuration in which the diaphragm 14 is located on the frame member 17 side and the supporting member 15 is located on the frame member 12 side is possible. The oscillator 16 may include two diaphragms 14 and a supporting member 15. These diaphragms 14 are attached to the supporting member 15 such that one diaphragm 14 is provided on the upper surface side of the supporting member 15 and the other diaphragm 14 is provided on the lower surface side of the supporting member 15.

The oscillator 16 vibrates by receiving sound that has entered the partial space 22. Specifically, the diaphragm 14 vibrates by receiving sound that has entered the partial space 22, and the central member 152 of the supporting member 15 vibrates in association with the vibration of the diaphragm 14. The oscillator 16 has two types of sound absorption characteristics. A first type of sound absorption characteristics are obtained by the central member 152 vibrating in the Y-axis direction and also the diaphragm 14 vibrating in accordance with the vibration of the central member 152. A second type of sound absorption characteristics are obtained by vibration of the diaphragm 14 itself which is also called a diaphragm vibration or a membrane vibration. A partial region of the diaphragm 14 is attached to the supporting member 15, and diaphragm vibration is possible in the other region of the diaphragm 14. The second type of sound absorption characteristics occur in a higher frequency band than the first type of sound absorption characteristics. In the embodiment, the second type of sound absorption characteristics are mainly utilized.

In the sound absorption apparatus 10 having the above-described configuration, the structure forming the partial space 23 (specifically, the perforated front plate 11 and the frame member 12) functions as a Helmholtz resonator of a one-degree-of-freedom system. The partial space 23 is a closed space for forming a Helmholtz resonator of a one-degree-of-freedom system. Further, the structure forming the partial space 22 and the internal space 24 functions as a Helmholtz resonator of a two-degrees-of-freedom system. Specifically, the structure forming the partial space 22 (specifically, the perforated front plate 11, the frame member 12, the spacer 13, and the oscillator 16) functions as a Helmholtz resonator of a one-degree-of-freedom system, and the oscillator 16 (specifically, the structure forming the internal space 24) adds a one-degree-of-freedom system. A two-degrees-of-freedom system is obtained by coupling of the Helmholtz resonator and the oscillator 16. The Helmholtz resonator of a two-degrees-of-freedom system has sound absorption characteristics in which a sound absorption coefficient peak is separated into two.

The one-degree-of-freedom system corresponding to the oscillator 16 can be designed by the mass of the diaphragm 14, the stiffness of the diaphragm 14, the stiffness of the connecting member 153, the stiffness of an air spring based on the internal space 24 as an air layer, etc. The mass and stiffness of the diaphragm 14 can be adjusted by, for example, the shape of the central member 152 and the thickness and material of the diaphragm 14. The mass of the diaphragm 14 specifically refers to the mass of a region of the diaphragm 14 where diaphragm vibration is possible. The larger the dimensions of the central member 152 are, the lower the mass of diaphragm 14 is, and the larger the stiffness of the diaphragm 14 is. The diaphragm 14 has viscoelasticity, and a damping effect, which most influences the sound absorption effect, can be generated by the viscoelasticity of the diaphragm 14. The damping effect can be adjusted by changing conditions for supporting the diaphragm 14 or by providing diaphragms 14 on both surfaces of the supporting member 15. The conditions for supporting the diaphragm 14 will now be described. Since the diaphragm 14 is attached to the central member 152, the boundary conditions of diaphragm vibration change according to the vibration mode of the central member 152. This change can be used to adjust the damping effect. Specifically, the boundary conditions change according to the frequency of the vibration mode. In a case where the frequency of the vibration mode is reduced, the diaphragm 14 is less restrained by the central member 152 (the diaphragm 14 moves more easily), and the damping effect is enhanced. Conversely, in a case where the frequency of the vibration mode is increased, the diaphragm 14 is more restrained by the central member 152 (the diaphragm 14 moves less easily), and the damping effect is weakened. In the second type of sound absorption characteristics obtained by diaphragm vibration, the change natural frequency due to the change in the stiffness of the connecting member 153 is minute; however, the change in the stiffness of the connecting member 153 has influence as a change in the boundary conditions of diaphragm vibration, and can be included in design elements as a fine adjustment of the damping effect. The stiffness of the air spring based on the internal space 24 can be adjusted by the thickness L2 of the frame member 17, and can be effectively used as a parameter for adjusting the natural frequency of the one-degree-of-freedom system. Also, a method in which the connecting member 153 is attached to the diaphragm 14 to divide the diaphragm 14 and thus the natural frequency is changed is possible. The number of divisions changes with the number of connecting members 153 bonded to the diaphragm 14, and thus the natural frequency can be changed with the number of connecting members 153.

An embodiment using the second type of sound absorption characteristics has the following features.
Design and adjustment are easy. For example, the natural frequency can be determined by design of the shape of the central member 152 and the material and thickness of the diaphragm 14. Also, a method in which the connecting member 153 is attached to the diaphragm 14 to change the natural frequency is possible.
Impartation of damping can be achieved by attaching the diaphragm 14 to the supporting member 15. From the viewpoint of energy dissipation, the combination of the diaphragm 14 and the supporting member 15 is more desirable than a simple elastic plate, and does not require provision of a damping material. The damping effect can be adjusted also by changing the boundary conditions of the diaphragm 14 based on the central member 152 and the connecting member 153.
The diaphragm 14 plays two roles of an acoustic barrier effect and the impartation of damping mentioned above. The damping effect can be strengthened by providing diaphragms 14 on both surfaces of the supporting member 15.

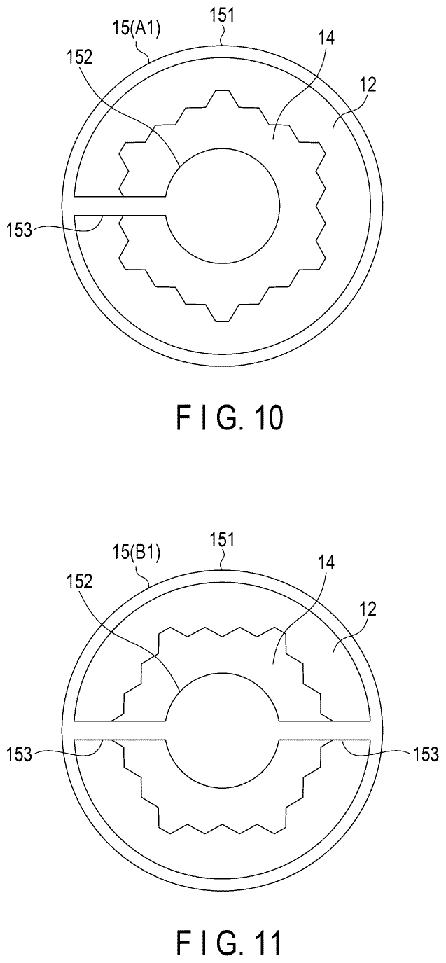

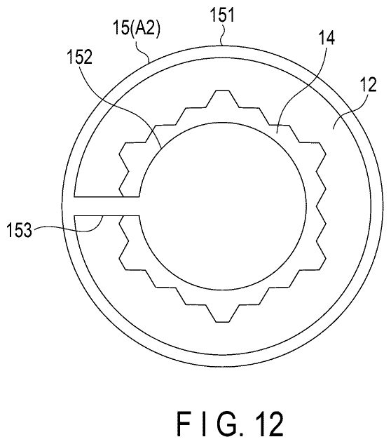

The sound absorption performance of the sound absorption apparatus 10 according to the embodiment will now be described. Herein, results of measurement of sound absorption characteristics for sound absorption apparatuses 10 according to three examples having different structures of the supporting member 15 are described. FIG. 10 schematically shows a sound absorption apparatus 10 according to a first example, FIG. 11 schematically shows a sound absorption apparatus 10 according to a second example, and FIG. 12 schematically shows a sound absorption apparatus 10 according to a third example. As shown in FIG. 10, in the first example, the number of connecting members 153 is one. As shown in FIG. 11, in the second example, the number of connecting members 153 is two. As shown in FIG. 12, in the third example, the central member 152 is larger than that in the first example. The structure of the supporting member 15 shown in FIG. 10 is referred to as structure A1, the structure of the supporting member 15 shown in FIG. 11 is as structure B1, and the structure of the supporting member 15 shown in FIG. 12 is as structure A2. Except for the structure of the supporting member 15, the structure is common to the first to third examples. The perforated front plate 11 has a diameter of 54 mm and a thickness of 1 mm. In the perforated front plate 11, 61 sound holes 111 are arranged in a honeycomb configuration. The diameter of the sound hole 111 is 1 mm. In the first and second examples, the thickness of the frame member 12 is 36 mm, and the thickness of the bottom plate of the frame member 12 is 2 mm. The thickness of the spacer 13 is 3 mm. In this case, the length of the partial space 22 is 39 mm, and the length of the partial space 23 is 34 mm. In the third example, the thickness of the frame member 12 is 26 mm, and the thickness of the bottom plate of the frame member 12 is 2 mm. The thickness of the spacer 13 is 3 mm. In this case, the length of the partial space 22 is 29 mm, and the length of the partial space 23 is 24 mm.

The diaphragm 14 is made of silicon rubber, and the diaphragm 14 has a thickness of 0.5 mm. In this case, the diaphragm 14 is translucent. The supporting member 15 is made of ABS (acrylonitrile butadiene styrene). The supporting member 15 of FIG. 10 has the structure shown in FIG. 8, and the frame member 151 has an outer diameter of 60 mm, an inner diameter of 54 mm, and a thickness of 3 mm. The central member 152 has a diameter of 20 mm and a thickness of 3 mm. The connecting member 153 has a thickness of 1.5 mm and a width of 3 mm. The connecting member 153 is placed in agreement with the center of the central member 152 in the Y-axis direction, and the diaphragm 14 and the connecting member 153 do not come into contact with each other. The supporting member 15 of FIG. 11 is a structure in which there are two connecting members 153. The supporting member 15 of FIG. 12 is a structure in which the diameter of the central member 152 is set to 30 mm. The thickness of the frame member 17 is 3 mm, and the thickness of the back plate 18 is 5 mm.

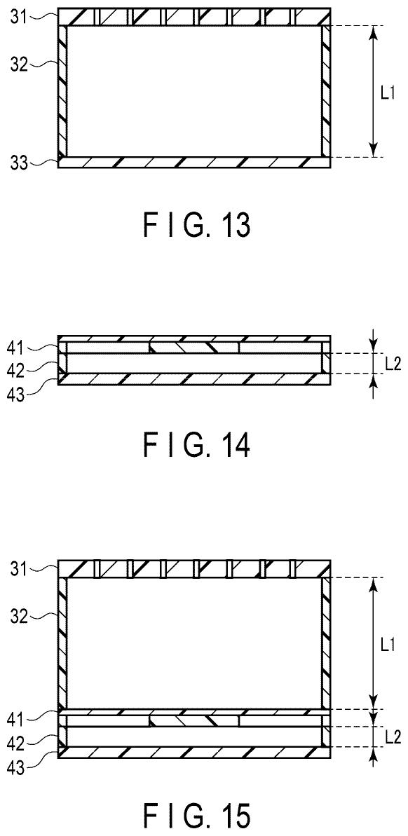

Also, measurement on sound absorption apparatuses according to a first comparative example, a second comparative example, and a third comparative example described below was performed. The sound absorption apparatuses according to the first comparative example, the second comparative example, and the third comparative example correspond to parts of the sound absorption apparatus 10 according to the embodiment. As shown in FIG. 13, the sound absorption apparatus according to the first comparative example is a Helmholtz resonator including a perforated front plate 31, a frame member 32, and a back plate 33. The perforated front plate 31 is similar to the perforated front plate 11, the frame member 32 is similar to the outer frame 121 of the frame member 12, and the back plate 33 is similar to the back plate 18. The perforated front plate 31 is connected to the frame member 32 in such a way as to close a first opening end of the frame member 32, and the back plate 33 is connected to the frame member 32 in such a way as to close a second opening end of the frame member 32. An internal space is formed by the perforated front plate 31, the frame member 32, and the back plate 33. As shown in FIG. 14, the sound absorption apparatus according to the second comparative example includes an oscillator 41, a frame member 42, and a back plate 43. The oscillator 41 is similar to the oscillator 16, the frame member 42 is similar to the frame member 17, and the back plate 43 is similar to the back plate 18. As shown in FIG. 15, the sound absorption apparatus according to the third comparative example is a structure in which the sound absorption apparatus according to the first comparative example and the sound absorption apparatus according to the second comparative example are coupled, and functions as a Helmholtz resonator of a two-degrees-of-freedom system. The sound absorption apparatus according to the third comparative example corresponds to a structure in which the space dividing member 122 is removed from the sound absorption apparatus 10.

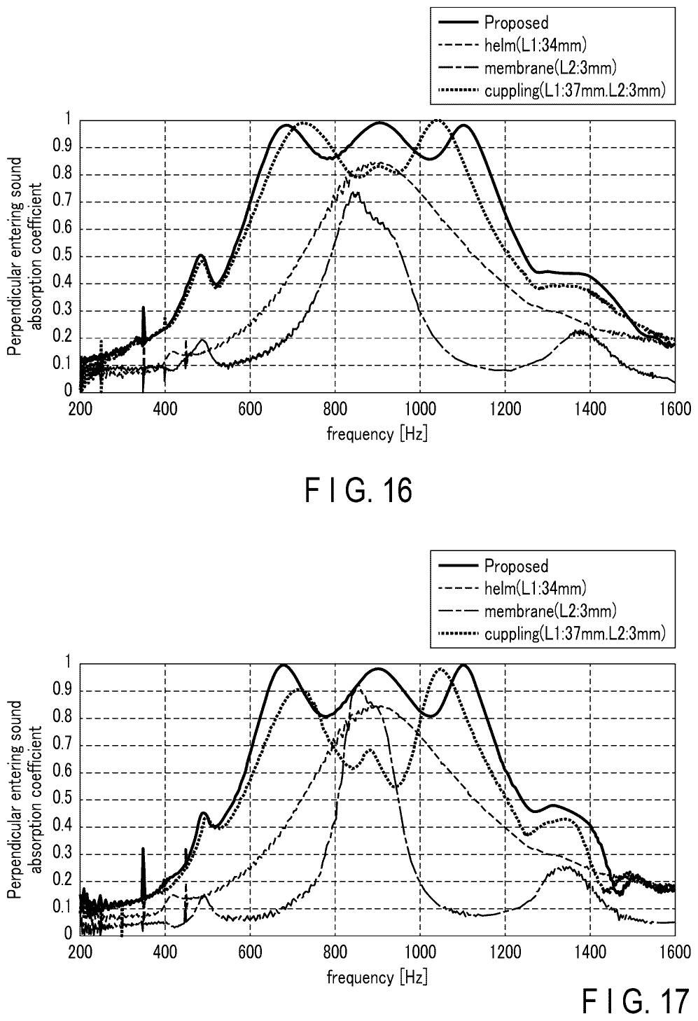

FIG. 16 schematically shows results of measurement of sound absorption performance according to the first example. In FIG. 16, the solid line indicates a result of measurement of sound absorption performance regarding the sound absorption apparatus 10 according to the embodiment, the broken line indicates a result of measurement of sound absorption performance regarding the sound absorption apparatus according to the first comparative example, the alternate long and short dash line indicates a result of measurement of sound absorption performance regarding the sound absorption apparatus according to the second comparative example, and the dotted line indicates a result of measurement of sound absorption performance regarding the sound absorption apparatus according to the third comparative example. Lengths L1 and L2 are the values shown in the drawings.

As shown in FIG. 16, in the sound absorption apparatus according to the third comparative example, a valley characteristic (a drop in sound absorption coefficient) occurs between two sound absorption coefficient peaks. In contrast, in the sound absorption apparatus 10 according to the embodiment, a valley characteristic occurring in the sound absorption apparatus according to the third comparative example is suppressed, and as a result a higher sound absorption effect is obtained in a wider frequency band. The sound absorption frequency band in which the sound absorption coefficient is 0.85 or more is as wide as 633 Hz to 1155 Hz (a width of 522 Hz). The width of the sound absorption frequency band in which the sound absorption coefficient is 0.8 or more is 544 Hz, and the width of the sound absorption frequency band in which the sound absorption coefficient is 0.7 or more is 588 Hz. The sound absorption apparatus 10 achieves greatly improved sound absorption performance over the Helmholtz resonator shown in FIG. 13 by simply being 11 mm thicker than the Helmholtz resonator.

FIG. 17 schematically shows results of measurement of sound absorption performance according to the second example. In FIG. 17, the solid line indicates a result of measurement of sound absorption performance regarding the sound absorption apparatus 10 according to the embodiment, the broken line indicates a result of measurement of sound absorption performance regarding the sound absorption apparatus according to the first comparative example, the alternate long and short dash line indicates a result of measurement of sound absorption performance regarding the sound absorption apparatus according to the second comparative example, and the dotted line indicates a result of measurement of sound absorption performance regarding the sound absorption apparatus according to the third comparative example. In the measurement herein, a supporting member having the structure shown in FIG. 11, that is, a supporting member having higher diaphragm support stiffness is used. From FIG. 17, it can be seen that, in the sound absorption apparatus 10 according to the embodiment, a valley characteristic occurring in the sound absorption apparatus according to the third comparative example is suppressed and the sound absorption apparatus 10 according to the embodiment has a higher sound absorption effect in a wider frequency band.

The difference between the sound absorption apparatus 10 according to the embodiment and the sound absorption apparatus according to the third comparative example is that the sound absorption apparatus 10 includes a space dividing member 122 that is provided in the frame member 12 and divides the internal space 21. Thus, it can be seen that a valley characteristic occurring in the sound absorption apparatus according to the third comparative example can be effectively suppressed by providing the space dividing member 122 in the frame member 12.

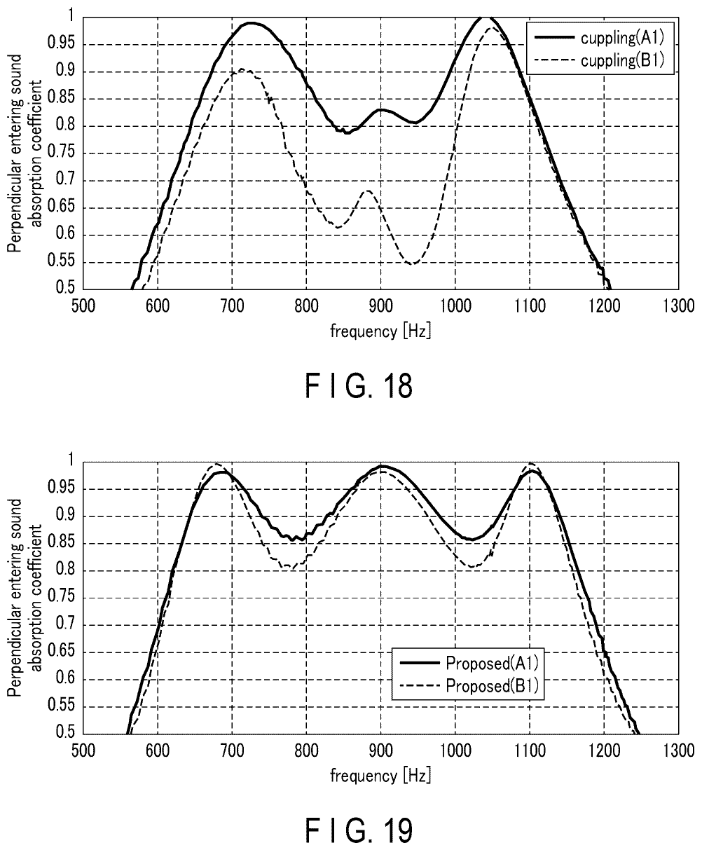

FIG. 18 shows a measurement result (the solid line) regarding the sound absorption apparatus according to the third comparative example shown in FIG. 16 and a measurement result (the broken line) regarding the sound absorption apparatus according to the third comparative example shown in FIG. 17, and FIG. 19 shows a measurement result (the solid line) regarding the sound absorption apparatus 10 according to the embodiment shown in FIG. 16 and a measurement result (the broken line) regarding the sound absorption apparatus 10 according to the embodiment shown in FIG. 17. From FIG. 18, it can be seen that the sound absorption performance of the sound absorption apparatus according to the third comparative example greatly depends on the diaphragm support stiffness of the supporting member included in the oscillator 41. From FIG. 19, it can be seen that the sound absorption performance of the sound absorption apparatus 10 according to the embodiment depends on the diaphragm support stiffness of the supporting member 15. In either case, in a case where the diaphragm support stiffness is smaller, the sound absorption performance is higher. Thus, in the sound absorption apparatus 10 according to the embodiment, the level at which a valley characteristic is to be suppressed can be adjusted by changing diaphragm support stiffness.

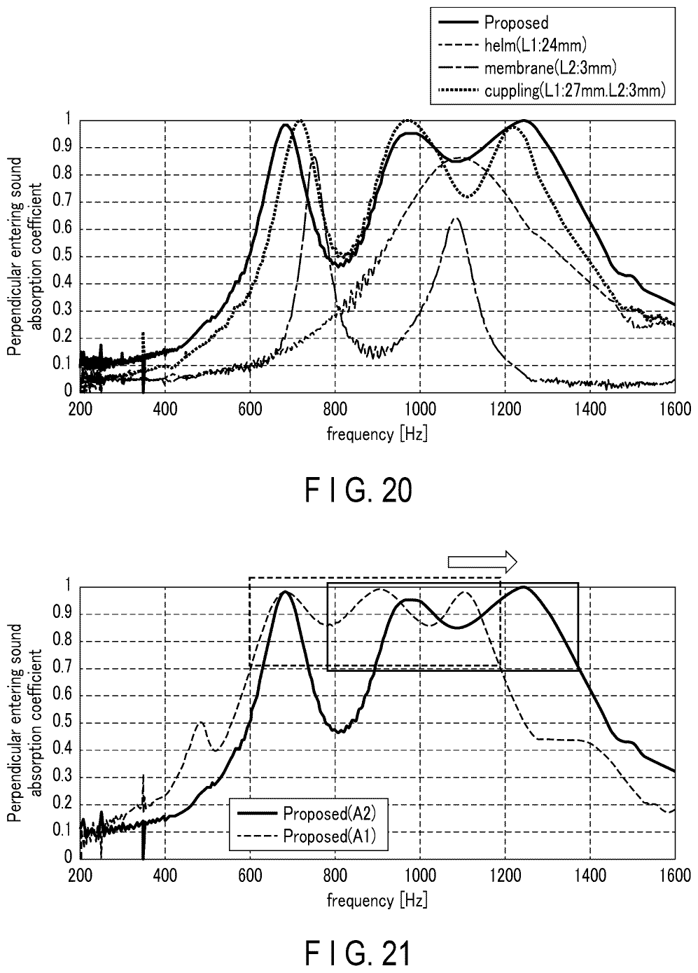

FIG. 20 schematically shows results of measurement of sound absorption performance according to the third example. In FIG. 20, the solid line indicates a result of measurement of sound absorption performance regarding the sound absorption apparatus 10, the broken line indicates a result of measurement of sound absorption performance regarding the sound absorption apparatus according to the first comparative example, the alternate long and short dash line indicates a result of measurement of sound absorption performance regarding the sound absorption apparatus according to the second comparative example, and the dotted line indicates a result of measurement of sound absorption performance regarding the sound absorption apparatus according to the third comparative example. In the measurement herein, a supporting member 15 having the structure shown in FIG. 12, that is, a supporting member 15 in which the central member 152 is larger is used. From FIG. 20, it can be seen that, in the sound absorption apparatus 10 according to the embodiment, a valley characteristic occurring in the sound absorption apparatus according to the third comparative example is suppressed and the sound absorption apparatus 10 according to the embodiment has a higher sound absorption effect in a wider frequency band. The sound absorption coefficient peak near 700 Hz corresponds to the first type of sound absorption characteristics described above.

FIG. 21 shows a measurement result (the broken line) regarding the sound absorption apparatus 10 according to the embodiment shown in FIG. 16 and a measurement result (the solid line) regarding the sound absorption apparatus 10 according to the embodiment shown in FIG. 20. From FIG. 21, it can be seen that the sound absorption frequency band changes according to the shape of the central member 152 included in the supporting member 15 and length L1. Thus, the sound absorption frequency band can be adjusted by changing the shape of the central member 152.

The valley characteristic changes according to the material of the diaphragm 14. For example, in a case where a diaphragm made of PVC (a PVC diaphragm) is used as the diaphragm 14, a valley characteristic is smaller than in a case where a diaphragm made of silicon rubber (a silicon diaphragm) is used as the diaphragm 14. However, the PVC diaphragm has a disadvantage that it cannot be used in a high-temperature environment. On the other hand, the silicon diaphragm has heat resistance, and can be used even in a high-temperature environment. Further, the silicon diaphragm, which is a heat-resistant material, has resistance also to deterioration over time. Even in a case where a silicon diaphragm is used as the diaphragm 14, the sound absorption apparatus 10 according to the embodiment has a sufficiently high sound absorption effect in a wide frequency band as shown in FIGS. 16, 17, and 20.

In the embodiment, a combination of the diaphragm 14 and the supporting member 15 is used as the oscillator 16. Thereby, the design of the natural frequency becomes easy. Further, by providing the space dividing member 122 in the frame member 12, even in a case where a heat-resistant material such as silicon rubber is used as the material of the diaphragm 14, a valley characteristic occurring between sound absorption coefficient peaks can be suppressed, and a high sound absorption effect can be obtained in a wide frequency band. Further, also under conditions where the structural strength of the supporting member 15 is increased as shown in FIG. 11, as shown in FIG. 17, the difference in the effect of suppressing a valley characteristic between the third comparative example and the sound absorption apparatus 10 is significant, and the sound absorption apparatus 10 according to the present embodiment can be used also for an apparatus or the like in which some structural strength is required. Herein, the heat-resistant material can refer to materials having heat resistance higher than the heat resistance of PVC, such as silicon rubber, fluororubber, acrylic rubber, ethylene propylene rubber, an ethylene-vinyl acetate copolymer, and a substance having these in the skeleton. The heat-resistant material is, for example, an elastic material. The heat-resistant material is, for example, a resin. The heat-resistant material has, for example, a melting point of higher than 200 degrees Celsius. The heat-resistant material desirably has a heat-resistant temperature (high-temperature use limit) of 150 degrees or higher, more desirably 200 degrees or higher. In a case where a silicon diaphragm is used as the diaphragm 14 and also constituent elements other than the diaphragm 14 contain a material having high heat resistance, the sound absorption apparatus 10 can be used in a high-temperature environment such as an environment of about 100 degrees or higher and 200 degrees or lower, for example. The heat-resistant material can be selected according to the temperature of the environment, light irradiation condition, the presence or absence of an organic solvent atmosphere, the presence or absence of moisture, etc., as appropriate.

As hereinabove, the sound absorption apparatus 10 according to the embodiment includes a perforated front plate 11 having a plurality of sound holes 111, an oscillator 16 facing the perforated front plate 11, a frame member 12 that is connected to the perforated front plate 11 and the oscillator 16 and forms an internal space 21 between the perforated front plate 11 and the oscillator 16, a back plate 18 facing the oscillator 16, and a frame member 17 that is connected to the back plate 18 and the oscillator 16 and forms an internal space 24 between the back plate 18 and the oscillator 16. The oscillator 16 includes a diaphragm 14 and a supporting member 15 that supports the diaphragm 14. The supporting member 15 includes a frame member 151 attached to the diaphragm 14, a central member 152 attached to the diaphragm 14, and a connecting member 153 coupling the frame member 151 and the central member 152. The frame member 12 includes a space dividing member 122 that divides the internal space 21 into partial spaces 22 and 23.

In the above configuration, the structure forming the partial space 22 and the internal space 24 functions as a Helmholtz resonator of a two-degrees-of-freedom system, and the structure forming the partial space 23 functions as a Helmholtz resonator of a one-degree-of-freedom system; by coupling of these, a high sound absorption effect can be obtained in a wide frequency band. Specifically, the structure forming the partial space 23 suppresses a valley characteristic between two sound absorption coefficient peaks caused by the structure forming the partial space 22 and the internal space 24, and thereby a high sound absorption effect is obtained in a wide frequency band.

By using a combination of the diaphragm 14 and the supporting member 15 as the oscillator 16, the design of the natural frequency of the sound absorption apparatus 10 becomes easy. Further, by adjusting the natural frequency of the supporting member 15, the damping effect can be adjusted, and a valley characteristic can be further improved.

In a case where the diaphragm 14 is made of a heat-resistant material such as silicon rubber, for example, the sound absorption apparatus 10 can be used even in a high-temperature environment where a common sound absorption material cannot be used. In a case where the diaphragm 14 is made of a heat-resistant material such as silicon rubber, a valley characteristic deteriorates as compared to a case where the diaphragm 14 is made of PVC. Since a valley characteristic is suppressed by the structure forming the partial space 23 as described above, a high sound absorption effect is obtained in a wide frequency band even in a case where a heat-resistant material is used for the diaphragm 14. Silicon rubber does not deteriorate over time; thus, the sound absorption apparatus 10 can be used for a long period of time, and the environmental load is low. Further, the sound absorption apparatus 10 can be used even in an environment where some structural strength of the supporting member 15 is required.

Further, since the sound absorption apparatus 10 has a hollow structure, the sound absorption apparatus 10 can be manufactured with small amounts of materials. Thus, the environmental load is low.

The sound absorption apparatus 10 described above can be used as each of a plurality of units included in an acoustic meta material. The acoustic meta material may be referred to as a sound absorption apparatus or a sound absorption system.

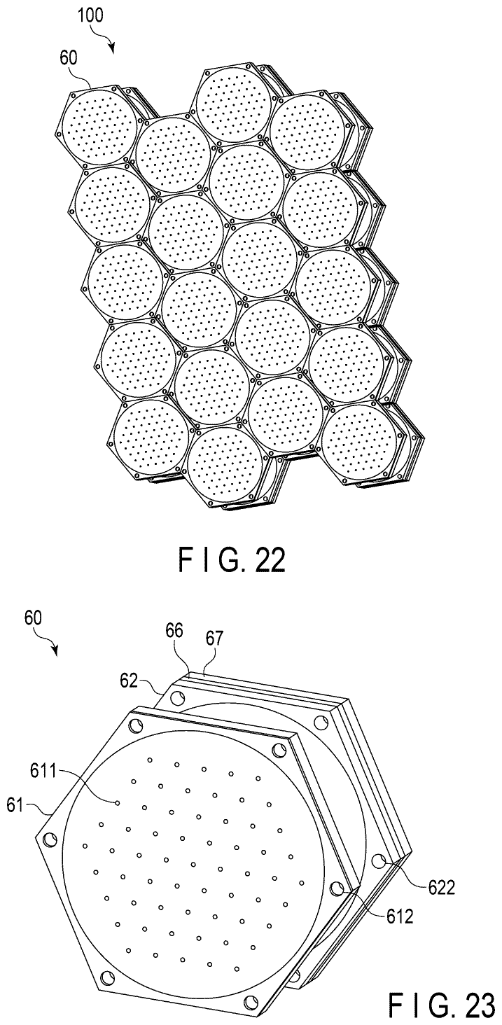

FIG. 22 schematically shows an acoustic meta material 100 according to an embodiment. As shown in FIG. 22, the acoustic meta material 100 includes a plurality of sound absorption units 60. The sound absorption units 60 are arranged periodically (in this example, in a honeycomb configuration). The sound absorption units 60 are fixed to each other using, for example, a band (not illustrated). Each sound absorption unit 60 has a similar configuration to the sound absorption apparatus 10 described with reference to FIGS. 1 to 7 except for the form of the external appearance. The sound absorption unit 60 has a hexagonal prism shape as a whole in order to be arranged in a honeycomb configuration.

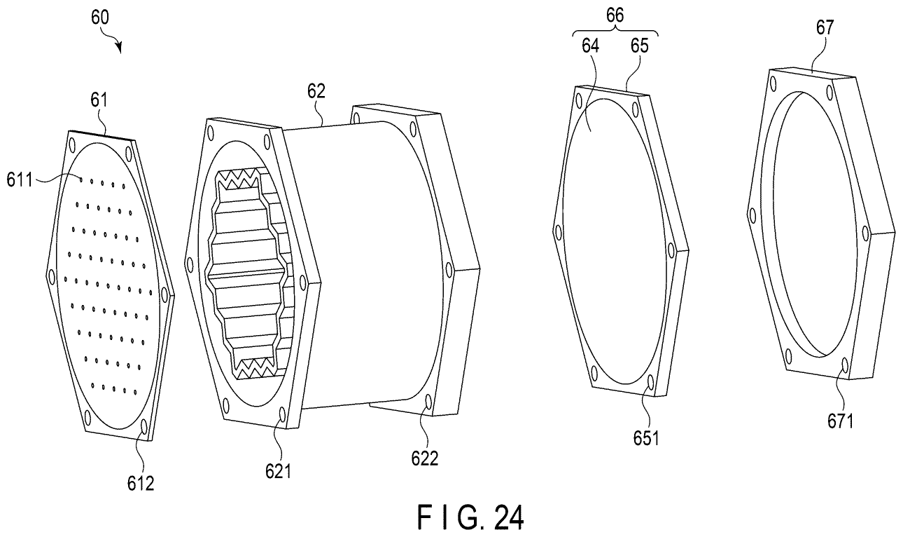

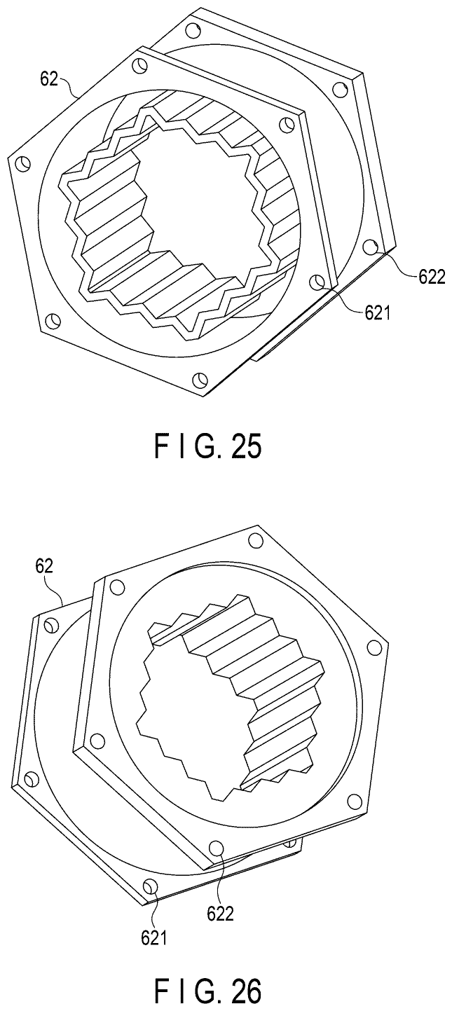

FIG. 23 schematically shows the sound absorption unit 60, FIG. 24 schematically shows the sound absorption unit 60 in a disassembled state, and FIGS. 25 and 26 schematically show part of the sound absorption unit 60. As shown in FIGS. 23 to 26, the sound absorption unit 60 includes a perforated front plate 61, a frame member 62, an oscillator 66, and a frame member 67.

The perforated front plate 61 is a hexagonal flat plate provided with a plurality of sound holes 611. The perforated front plate 61 corresponds to a structure in which a hexagonal outer frame is added to the perforated front plate 11 described above. Holes 612 for inserting bolts are provided in an outer edge portion of the perforated front plate 61.

The frame member 62 corresponds to a structure in which a hexagonal outer frame is added to each of an upper end portion and a lower end portion of the frame member 12 described above. Thus, a specific description of the frame member 62 is omitted. The outer frame located in the lower end portion functions also as the spacer 13 described above. Holes 621 and 622 for inserting bolts are provided in an outer edge portion of the frame member 62.

The oscillator 66 includes a diaphragm 64 and a supporting member 65 that supports the diaphragm 64. The diaphragm 64 corresponds to the diaphragm 14 described above, and the supporting member 65 corresponds to a structure in which a hexagonal outer frame is added to the supporting member 15 described above. Thus, a specific description of the oscillator 66 is omitted. Holes 651 for inserting bolts are provided in an outer edge portion of the supporting member 65.

The perforated front plate 61 is connected to the frame member 62 in such a way as to close a first opening end of the frame member 62, and the oscillator 66 is connected to the frame member 62 in such a way as to close a second opening end of the frame member 62.

The frame member 67 corresponds to a structure in which a hexagonal outer frame is added to a combination of the frame member 17 and the back plate 18 described above. Thus, a specific description of the frame member 67 is omitted. Holes 671 for inserting bolts are provided in an outer edge portion of the frame member 67. The oscillator 66 is connected to the frame member 67 in such a way as to close an opening end of the frame member 67.

In a state where bolts are inserted into the holes 612, the holes 621, the holes 622, the holes 651, and the holes 671, nuts are screwed onto the bolts; thereby, the perforated front plate 61, the frame member 62, the oscillator 66, and the frame member 67 are fixed.

The acoustic meta material 100 having the above-described configuration can effectively absorb sound such as noise.

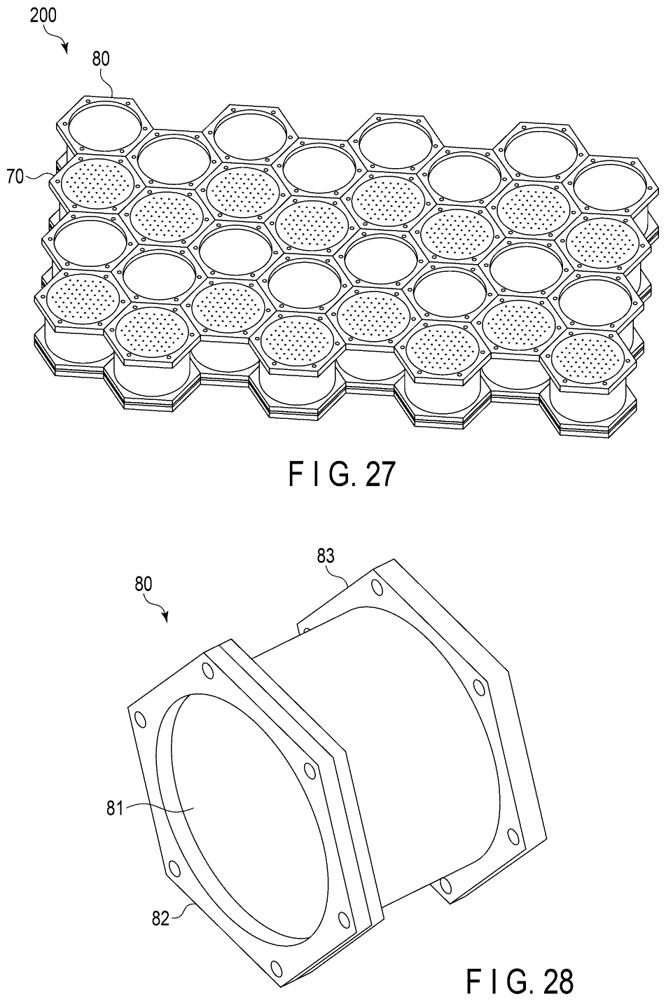

FIG. 27 schematically shows an acoustic meta material 200 according to an embodiment. As shown in FIG. 27, the acoustic meta material 200 includes a plurality of sound absorption units arranged in a honeycomb configuration, including a plurality of sound absorption units 70 and a plurality of sound absorption units 80. The sound absorption unit 70 and the sound absorption unit 80 are alternately arranged. The arrangement pattern shown in FIG. 27 is an example. The number of sound absorption units 70 may be different from the number of sound absorption units 80.

The sound absorption unit 70 is the same as the sound absorption unit 60 described with reference to FIGS. 23 to 26. Thus, a description of the sound absorption unit 70 is omitted.

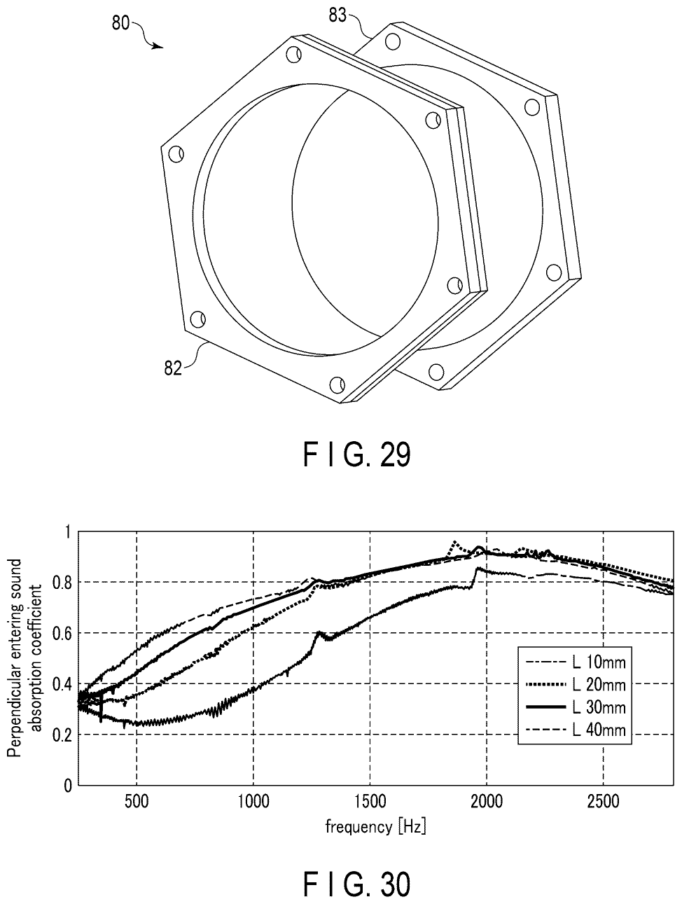

FIG. 28 schematically shows the sound absorption unit 80, and FIG. 29 schematically shows part of the sound absorption unit 80. As shown in FIGS. 28 and 29, the sound absorption unit 80 includes a cloth 81, a supporting member 82, and a frame member 83. As the cloth 81, a cloth containing aramid fiber, for example, polyparaphenylene terephthalamide fiber can be used. A woven fabric based on a single material may be used, or a blended fabric containing the above fiber may be used. The cloth 81 is stretched on the ring-like supporting member 82. The supporting member 82 supports the cloth 81. The cloth 81 is connected to the frame member 83 via the supporting member 82 such that the cloth 81 closes an opening end of the frame member 83. The supporting member 82 is fixed to the frame member 83 by using, for example, a combination of bolts and nuts. An internal space is formed by the cloth 81 and the frame member 83. In order to hold the shape of the cloth 81, the cloth 81 may be sandwiched between pieces of perforated metal.

FIG. 30 shows results of measuring sound absorption characteristics of the sound absorption unit 80. As shown in FIG. 30, the sound absorption unit 80 using the cloth 81 exhibits a high sound absorption effect at 1.2 kHz or higher. Further, it can be seen that the sound absorption effect becomes higher as the air layer of the sound absorption unit 80 becomes longer.

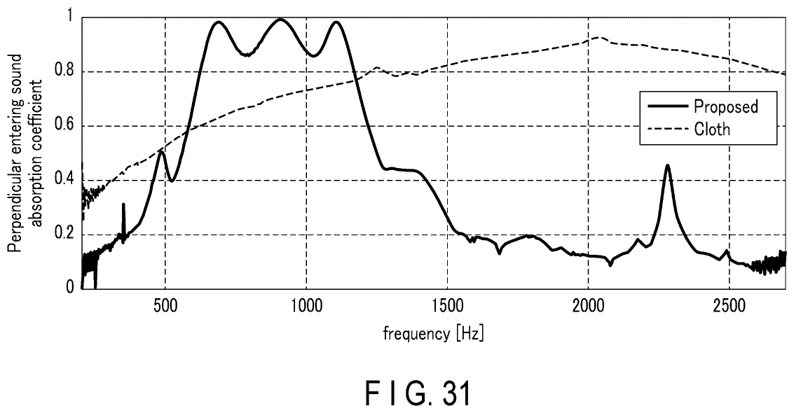

As shown in FIGS. 21, 30, and 31, the sound absorption effect of the sound absorption unit 70 is high in a frequency band in which the sound absorption effect of the sound absorption unit 80 is low. Thus, by using the acoustic meta material 200, a high sound absorption effect can be obtained in a wide frequency band. Specifically, the sound absorption unit 70 exhibits high sound absorption coefficients at about 600 Hz to about 1100 Hz, and the sound absorption unit 80 exhibits high sound absorption coefficients at about 1100 Hz to about 2700 Hz. In the superposition of the sound absorption characteristics of the sound absorption unit 70 and the sound absorption unit 80, the frequency band in which the reflected sound is suppressed to a quarter or less ranges from as low as about 600 Hz to as high as about 2700 Hz.

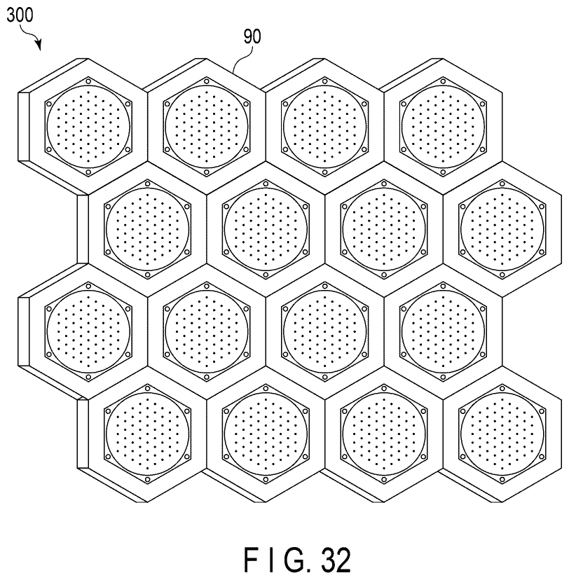

FIG. 32 schematically shows an acoustic meta material 300 according to an embodiment. As shown in FIG. 32, the acoustic meta material 300 includes a plurality of sound absorption units 90 arranged in a honeycomb configuration.

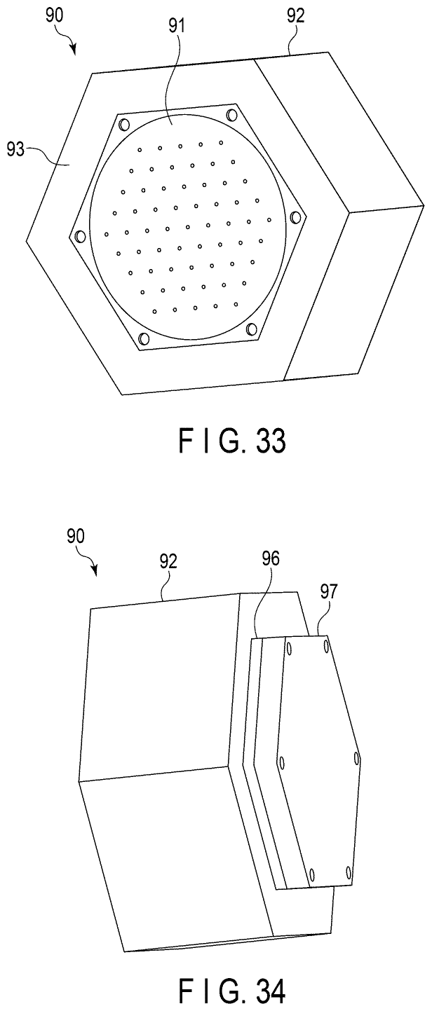

FIGS. 33 and 34 schematically show the sound absorption unit 90. As shown in FIGS. 33 and 34, the sound absorption unit 90 includes a perforated front plate 91, a frame member 92, an oscillator 96, a frame member 97, and a cloth 93. The sound absorption unit 90 is the same as the sound absorption unit 60 described with reference to FIGS. 23 to 26 except that the shape of the frame member 92 is different from the shape of the frame member 62 and that the cloth 93 is provided. In other words, the perforated front plate 91 has the same configuration as the perforated front plate 61, the oscillator 96 has the same configuration as the oscillator 66, and the frame member 97 has the same configuration as the frame member 67. Thus, a description of the perforated front plate 91, the oscillator 96, and the frame member 97 is omitted. As the cloth 93, for example, a cloth containing aramid fiber can be used.

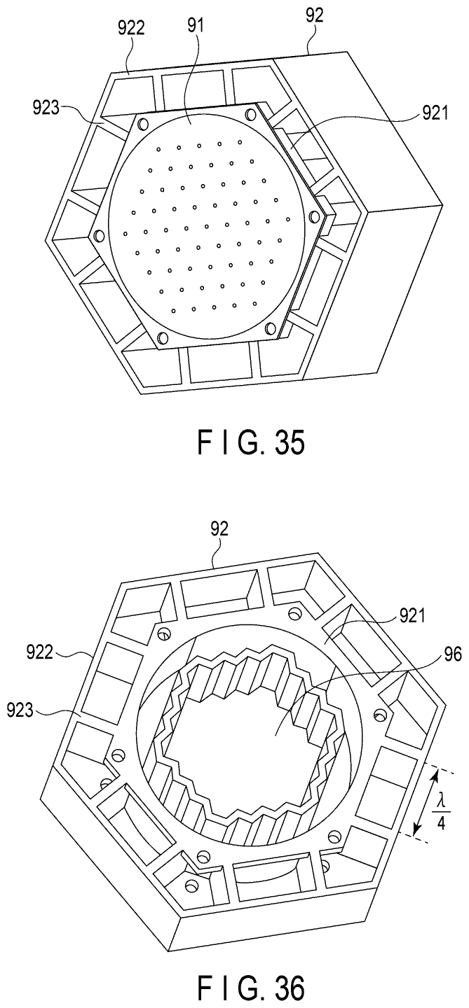

FIG. 35 schematically shows the sound absorption unit 90 from which the cloth 93 is removed, and FIG. 36 schematically shows the sound absorption unit 90 from which the perforated front plate 91 and the cloth 93 are removed. As shown in FIGS. 35 and 36, the frame member 92 is a structure in which the frame member 62 is expanded so as to add a region where the cloth 93 is to be placed. The frame member 92 includes a base portion 921 corresponding to the frame member 62 and an expansion portion 922 provided around the base portion 921. The expansion portion 922 has a structure in which an internal space is formed by the expansion portion 922 and the cloth 93. The internal space formed by the expansion portion 922 and the cloth 93 is a space separated from the internal spaces 21 and 24 shown in FIG. 4. The cloth 93 is connected to the expansion portion 922 in such a way as to close an opening end of the expansion portion 922, and an end portion of the expansion portion 922 to which the cloth 93 is not connected is closed. The expansion portion 922 is provided with division walls 923 that divide the internal space into a plurality of partial spaces. In a case where the wavelength of the maximum frequency of a frequency band in which the cloth 93 is desired to absorb sound is denoted by λ, the division walls 923 are arranged such that a characteristic length is λ/4.

The cloth 93 and the expansion portion 922 of the frame member 92 have sound absorption performance substantially equal to that of the sound absorption unit 80 described with reference to FIG. 28. Thus, by using the acoustic meta material 300, a high sound absorption effect can be obtained in a wide frequency band like in the acoustic meta material 200.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sound absorption apparatus comprising:
a front plate comprising a plurality of sound holes;
an oscillator facing the front plate;
a first frame member connected to the front plate and the oscillator, the first frame member forming a first space between the front plate and the oscillator;
a back plate facing the oscillator; and
a second frame member connected to the back plate and the oscillator, the second frame member forming a second space between the back plate and the oscillator,
wherein the oscillator comprises a diaphragm, a third frame member attached to the diaphragm, a central member attached to the diaphragm, and a connecting member coupling the third frame member and the central member, and
the first frame member comprises a space dividing member that divides the first space.

2. The sound absorption apparatus according to claim 1, wherein
the oscillator is connected to the first frame member via a spacer such that the oscillator does not come into contact with the space dividing member.

3. The sound absorption apparatus according to claim 1, wherein
the space dividing member divides the first space into a first partial space and a second partial space, the second partial space being isolated from the oscillator, and
the second partial space is provided to surround the first partial space.

4. The sound absorption apparatus according to claim 1, wherein
the space dividing member divides the first space into a first partial space and a second partial space, the second partial space being isolated from the oscillator, and
the first partial space is provided to surround the second partial space.

5. The sound absorption apparatus according to claim 1, wherein
the connecting member supports the central member such that the central member is capable of vibrating with respect to the third frame member.

6. The sound absorption apparatus according to claim 1, wherein
the third frame member and the central member are attached to a first region of the diaphragm, and
sound entering the first space through the sound holes is reduced by using a sound absorption characteristic occurring due to vibration of a second region of the diaphragm different from the first region.

7. The sound absorption apparatus according to claim 1, wherein
the connecting member is attached to the diaphragm.

8. The sound absorption apparatus according to claim 1, wherein
a supporting member comprising the third frame member, the central member, and the connecting member comprises a first surface and a second surface on an opposite side to the first surface, and the diaphragm comprises a first diaphragm provided on a side of the first surface of the supporting member and a second diaphragm provided on a side of the second surface of the supporting member.

9. The sound absorption apparatus according to claim 1, wherein
the central member is bonded to the diaphragm.

10. The sound absorption apparatus according to claim 1, wherein
the central member is fixed to the diaphragm by using a magnet.

11. The sound absorption apparatus according to claim 1, wherein
the diaphragm is made of a heat-resistant material.

12. The sound absorption apparatus according to claim 11, wherein
the diaphragm is made of silicon rubber.

13. An acoustic meta material comprising:
a plurality of first sound absorption units; and
a plurality of second sound absorption units,
wherein each of the first sound absorption units comprises the sound absorption apparatus according to claim 1, and
each of the second sound absorption units comprises a cloth and a fourth frame member connected to the cloth and a third space is formed by the cloth and the fourth frame member.

14. An acoustic meta material comprising
a plurality of sound absorption units,
wherein each of the sound absorption units comprises the sound absorption apparatus according to claim 1 and a cloth, and
a third space is formed by the cloth and the first frame member included in the sound absorption apparatus and the third space is separated from the first space and the second space.
